(19) United States
(12) Patent Application Publication
(10) Pub. No.: US 2006/0101491 A1
(43) Pub. Date: May 11, 2006

(54) Content recording/reproducting apparatus, cntent recording/reproducingmethod, and computer program

(76) Inventors: Yasushi Tsuruta, Tokyo (JP); Katsuro Matsuzaki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/514,624

(22) PCT Filed: May 19, 2003
(86) PCT No.: PCT/JP03/06188

§ 371 Date: Sep. 12, 2005

(30) Foreign Application Priority Data
May 23, 2002 (JP) 2002-148569

(51) Int. Cl. H04N 5/445; G06F 13/00; G06F 3/00

(52) U.S. Cl. 725/58; 725/39

(57) ABSTRACT

A video recording and reproducing apparatus can support viewing and reproduction of a recorded video content on the basis of viewing support information provided from another party. The viewing support information includes channel information specifying a program with respect to each broadcast program, comments on a specific scene within the program, and on-air time of the commented scene. On the side of a user who received the viewing support information, a scene on which a desired comment is made can be automatically found by search using its on-air time as a clue.

### TECHNICAL FIELD

This invention relates to a content recording and reproducing apparatus for recording and reproducing a content of audio, video or the like, and to a computer program, and particularly to a content recording and reproducing apparatus for recording and reproducing a content such as a broadcast program distributed from a broadcasting station or the like, and to a computer program.

More specifically, this invention relates to a content recording and reproducing apparatus and a content recording and reproducing method for automating the processing in specifying and reproducing a scene contained in a recorded broadcast content and thus supporting pleasant viewing, and to a computer program, and particularly to a content recording and reproducing apparatus and a content recording and reproducing method for automating the processing in reproducing a scene specified on the basis of information provided from an information provider and thus supporting pleasant viewing, and to a computer program.

### BACKGROUND ART

The progress of digital technology has been enabling storage of a large quantity of AV data including video and audio without deterioration. Recently, HDDs having a capacity of several ten GB or more have been available at relatively low prices and HDD-based recording machines have been introduced.

An HDD is a device in which recorded data can be randomly accessed. Therefore, when reproducing a recorded content, it is not necessary to sequentially reproduce recorded programs from the top part as in the case of conventional videotape, and reproduction of a desired program can be started directly.

However, as the capacity of HDDs has increased, users are troubled about selection of contents, that is, which program they should start viewing first, in the case where many programs are stored. In order to prevent locking away of contents stored for the purpose of viewing and effectively utilize the contents, it is considered necessary to perform certain support for viewing.

Meanwhile, in today's world, where computerization has been highly advanced, various information is digitized and sharing and distribution of the information via a network are realized. Therefore, unspecified users can share knowledge and experience with each other. Various bulletin board systems (BBS) are constructed on the Internet, and as unspecified users spontaneously write comments thereto, they can exchange problems and opinions on the same subject.

For example, bulletin board systems on the Internet with respect to television programs exist already. General people can make comments on programs that were broadcast, by writing, and other people can browse the comments.

A typical bulletin board system includes contributor's name (or handle name), date and time of contribution, and a comment writing field. Therefore, comprehensive information, opinions and comments on a “certain program” can be written. However, when a person who writes on the bulletin board wants to refer to a specific scene in the program, he/she must enter time information to specify the scene as a “character string”, for example, “a scene after approximately 10 minutes and 30 seconds from the beginning.” On the other hand, when a person who browses the bulletin board wants to confirm the scene, he/she must search for the scene by using a video recording apparatus such as VTR and using information (memory) about “what time the recording was started” and a time lapse counter of the apparatus, which is inconvenient.

### DISCLOSURE OF THE INVENTION

It is an object of this invention to provide an excellent content recording and reproducing apparatus, content recording and reproducing method and computer program that can support pleasant viewing by automating the processing in specifying and reproducing a scene contained in a recorded broadcast content.

It is another object of this invention to provide an excellent content recording and reproducing apparatus, content recording and reproducing method and computer program that can support pleasant viewing by automating the processing in reproducing a scene specified on the basis of information from an information provider.

In view of the foregoing problems, a first aspect of this invention provides a content recording and reproducing apparatus or a content recording and reproducing method for recording a content distributed in accordance with schedule time and supporting viewing, characterized by comprising:

content storage means or step to save a distributed content together with a distribution channel and time information about time of saving;

receiving means or step to receive viewing support information including at least distribution channel of the content, date and time of distribution of the content, and reproduction start point information of the content;

information analysis means or step to analyze the viewing support information; and

content presentation means or step to take out a corresponding content from the content storage means, and reproduce and output the content from a reproduction start point.

The distributed content described herein refers to, for example, an audio and video content of a broadcast program broadcast from each broadcasting station. The viewing support information refers to, for example, information such as comments on each scene of the broadcast program, provided from other users.

According to the content recording and reproducing apparatus or the content recording and reproducing method according to the first aspect of this invention, since the received viewing support information is analyzed and the corresponding content is taken out and reproduced and outputted from the reproduction start point, pleasant viewing can be supported by automating the processing in reproducing a scene specified on the basis of information from an information provider.

Also, according to the content recording and reproducing apparatus or the content recording and reproducing method according to the first aspect of this invention, as a user receives information from an information provider, the user can automatically find out a video content supposed by the information provider from many video contents existing on a database and can automatically reproduce the video from a scene supposed by the information provider.

When performing such processing, the user need not carry out complicated operations and the processing is performed simply by a single operation such as selecting a button. The video content can be reproduced from the scene supposed by the information provider without considering the difference in recording start time of the video content between users.

Moreover, even when the viewing support function is not used, that is, during ordinary video content reproduction or the like, the user need not carry out complicated operations and can display a screen for receiving provision of the viewing support information simply by a single operation, for example, pressing a button on a remote controller.

The content recording and reproducing apparatus or the content recording and reproducing method according to the first aspect of this invention may further comprise reproduction start point correction means or step to correct the reproduction start point of the content on the basis of the reproduction start point information.

This reproduction start point correction means or step compares saving start date and time of the content with distribution start date and time. If the saving start date and time precede the distribution start date and time, time difference between them may be added to the reproduction start point information. If the distribution start date and time precede the saving start date and time, time difference between them may be subtracted from the reproduction start point information.

In the case where the viewing support information includes a comment on the content, the content presentation means or step may output the comment in parallel at a corresponding presentation position.

Warning display means or step to display a warning to the user in response to the case where the content specified by viewing support information could not be taken out from the content storage means may also be provided. This warning display means or step may display a method for reserving the next distribution of the content.

The content recording and reproducing apparatus or the content recording and reproduction method according to the first aspect of this invention may further comprise viewing support information request means or step to acquire one or more items of viewing support information, and viewing support information list display means or step to display a list of the acquired viewing support information.

In such a case, the viewing support information request means or step may acquire the viewing support information in accordance with a request from the user.

Alternatively, the viewing support information request means or step may acquire the viewing support information from an external device automatically and periodically. Viewing support information storage means or step may be provided further, and the viewing support information list display means or step may take out the viewing support information from the viewing support information storage means in response to a request from the user and display a list thereof.

Also, the list of the viewing support information may be displayed by the viewing support information list display means or step after reproduction and output of the content by the content presentation means or step are stopped in response to the user's operation.

In response to the user's selection from the list of the viewing support information by the viewing support information list display means or step, the information analysis means or step may analyze the selected viewing support information, and the content presentation means may reproduce and output the corresponding content from the reproduction start point.

When performing such processing, the user need not carry out complicated operations and the processing is automatically performed simply by a single operation such as selecting a button. Moreover, the content can be reproduced from a scene supposed by the information provider without considering the difference in recording start time of the video content between users.

A second aspect of this invention provides a computer program described in a computer-readable format so as to execute processing to record a content distributed in accordance with schedule time and support viewing, on a computer system, characterized by comprising:

a content storage step to save a distributed content together with a distribution channel and time information about time of saving;

a receiving step to receive viewing support information including at least distribution channel of the content, date and time of distribution of the content, and reproduction start point information of the content;

an information analysis step to analyze the viewing support information; and

a content presentation step to take out a corresponding content from the contents stored at the content storage step, and reproduce and output the content from a reproduction start point.

The computer program according to the second aspect of this invention defines a computer program described in a computer-readable format so as to realize predetermined processing on a computer system. In other words, as the computer program according to the second aspect of this invention is installed in a computer system, cooperative effects are exhibited on the computer system, and effects and advantages similar to those of the content recording and reproducing apparatus or the content recording and reproducing method according to the first aspect of this invention can be achieved.

The other objects, features and advantages of this invention will be clarified by the following embodiments of this invention and the detailed description thereof based on the attached drawings.

### BRIEF DESCRIPTION OF THE DRAWINGS

FIG. 1 is a view schematically showing a hardware structure of a video recording and reproducing apparatus according to one embodiment of this invention.

FIG. 2 is a view showing an example of screen construction of a bulletin board on which comments on each scene of a certain program are gathered.

FIG. 3 is a block diagram schematically showing a mechanism for controlling a reproducing position of a recorded content on the basis of viewing support information in the video recording and reproducing apparatus according the one embodiment of this invention.

FIG. 4 is a view schematically showing a mechanism for controlling a reproducing position of a recorded content on the basis of viewing support information in the case of receiving the viewing support information via a web browser.

FIG. 5 is a flowchart showing processing procedures for searching for a video content on a search module.

FIG. 6 is a view schematically showing a mechanism for controlling a reproducing position of a video content based on viewing support information on the assumption that “recording start date and time” of video content information differs from “broadcast start date and time” of program information.

FIG. 7 is a view showing a state of displaying character string information (comments on broadcast program or the like) taken out from viewing support information, simultaneously with a video reproduction image.

FIG. 8 is a flowchart showing processing procedures for correcting a reproduction start point in the case where “recording start date and time” of video content information differs from “broadcast start date and time” of program information.

FIG. 9 is a view schematically showing a mechanism for performing post-processing in the case where search for a video content selected on the basis of viewing support information failed.

FIG. 10 is a flowchart showing procedures of post-processing in the case where search processing failed.

FIG. 11 is a view schematically showing a mechanism for a viewing support information site to provide a viewing support information list in accordance with a request from a user, that is, the video recording and reproducing apparatus.

FIG. 12 is a view schematically showing a mechanism for the user, that is, the video recording and reproducing apparatus, to acquire the viewing support information list from the viewing support information site automatically and periodically.

FIG. 13 is a view showing an example of display of a method for reserving the next broadcast of a program, of the viewing support information.

### BEST MODE FOR CARRYING OUT THE INVENTION

Hereinafter, an embodiment of this invention will be described in detail with reference to the drawings.

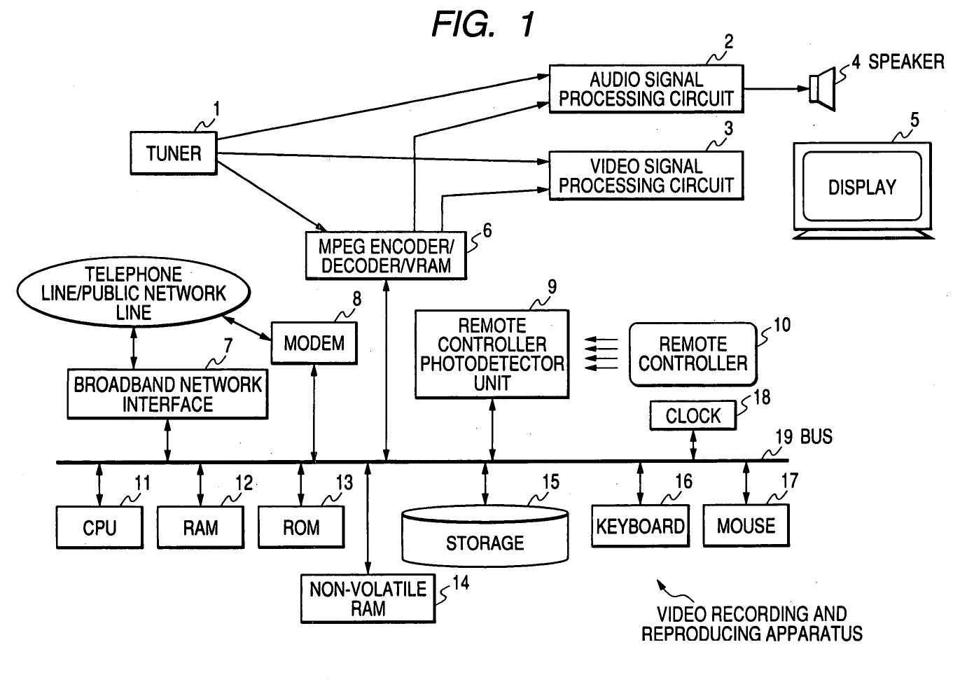

FIG. 1 schematically shows a hardware structure of a video recording and reproducing apparatus according to one embodiment of this invention. This video recording and reproducing apparatus has a tuner capable of receiving program broadcasting, a storage capable of storing video contents and a database of video contents, and a communication device capable of transmitting and receiving information to and from others on a network, as fundamental constituent elements.

In the example shown in FIG. 1, this video recording and reproducing apparatus has a tuner 1, an audio signal processing circuit 2, a video signal processing circuit 3, an MPEG (Moving Picture Experts Group) encoder/decoder/buffer VRAM 6, a broadband network interface 7, a modem 8, a remote control photodetector unit 9, a remote controller 10, a CPU (central processing unit) 11, a RAM (random access memory) for temporary storage 12, a ROM (read-only memory) for permanent data 13, a non-volatile RAM 14, a storage 15, a keyboard 16, a mouse 17, and a clock 18. Usually, reproduction output devices such as a speaker 4 and a display 5 are externally connected with the audio signal processing circuit 2 and the video signal processing circuit 3. The keyboard 16 and the mouse 17 can be replaced with other user input devices.

The CPU 11 is a main controller for generally controlling the overall operation of the video recording and reproducing apparatus, and it executes application programs in an execution environment provided by an operating system (OS). The CPU 11 is interconnected with each part and unit via a bus 19.

The RAM 12 is constituted by a writable semiconductor memory device and it is used, for example, for unfolding the OS and application programs or for temporarily storing work data at the time of executing a program. The ROM 13 is a read-only memory in which holding data has been permanently written. For example, a self-diagnostic program at the time of turning on the power of the video recording and reproducing apparatus, codes for hardware operations, a bootstrap module (module for starting the OS) and the like are stored therein.

In the non-volatile RAM 14, for example, ID information proper to the hardware set of the video recording and reproducing apparatus, ID information of the user, information about the local area where the user resides and the like are stored. Such information can also be stored in the storage 15, and in this case, the non-volatile RMA 14 can be omitted.

The storage 15 is constituted by, for example, a hard disk device (HDD), rewritable DVD disk or the like, and it is used for storing video contents and for storing information data (date and time of broadcast, channel, etc.) at the time of recording video contents. The other purposes of the storage 15 may include installation of the operating system (OS) and execution programs such as application programs and network connection programs (general-purpose web browser), and saving of data proper to application programs. However, the OS and application programs may be stored in the ROM 13 instead of the storage 15.

The user can operate the video recording and reproducing apparatus, using the remote controller 10 or the user input devices such as the keyboard 16 and the mouse 17. An operator command from the remote controller 10 is received by the remote controller photodetector unit 9 and transferred to the CPU 11 via the bus 19. Also, an operator command from the keyboard 16 or the mouse 17 is similarly transferred to the CPU 11. The CPU 11 processes the operator commands sent thereto from these input devices, and decides the operation of the video recording and reproducing apparatus.

On the display 5, a GUI (graphical user interface) screen for user operation is displayed in addition to a video that is on the air or being recorded or reproduced. For example, a list of video contents that can be reproduced is displayed. In such a case, the CPU 11 executes a GUI processing program, and a display image is generated in the buffer VRAM 6 and outputted to the display 5 via the video signal processing circuit 3. Therefore, the user can learn the state of the apparatus and operations that can be performed, via the display 5. However, not all the operation lists are displayed on the display 5.

When viewing a program on the air, the tuner 1 receives video and audio waves, program information (EPG: electric program guide), and information (meta data) related to the contents of the program. Under the control of the CPU 11, the audio signal and video signal are demodulated by the audio signal processing circuit 2 and the video signal processing circuit 3 and outputted outward from the speaker 4 and the display 5.

When recording a program, received video and audio signals are digitally compressed by the MPEG encoder 6 and are stored into the storage 15 under the control of the CPU 11. When the signals are stored into the storage 15, the RAM 12 may be used as a temporary data storage area.

Moreover, when recording a program, EPG information of the program to be recorded, recording start time and duration of recording, channel, genre to which the program belongs, information (meta data) related to the contents of the program and the like are also recorded into the storage 15, in addition to the video signal and audio signal. The meta data described here specifically includes an index within the program (like a bookmark within the program, made up of a combination of a certain time, comments on that time, and icon), a segment within the program (a part of the contents of the program, highlight scene or the like, made up of a combination of start time, end time, comments, and icon), a story made up of a segment, comment, and icon within one or more programs, other information related to the program, and the like. Such information may also be recorded in the non-volatile RAM 14.

The video recording and reproducing apparatus according to this embodiment can simultaneously perform viewing and recording of a program on the air. In this case, broadcast waves received by the tuner 1 are outputted to the MPEG encoder 6, the audio signal processing circuit 2, and the video signal processing circuit 3.

When reproducing a recorded program, compressed video and audio data are transferred to the MPEG decoder 6 from the storage 15 under the control of the CPU 11. After the video and audio data are decoded by the MPEG decoder 6, the video and audio data are demodulated by the audio signal processing circuit 2 and the video signal processing circuit 3 and outputted outward from the speaker 4 and the display 5. Here, when the data are transferred from the storage 15 to the MPEG decoder 6, the RAM 12 may be used as a temporary storage area. Also, when the MPEG decoder 6 expands the compressed data, the buffer VRAM 6 may be used as a temporary storage area.

During the reproduction of a program, the CPU 11 manages information such as which content is being reproduced and which temporal part is currently being reproduced, and temporarily records this information onto the RAM 12. Also, during the reproduction a program, information related to the information (meta data) about the contents of the program that is being used is also managed by the CPU 11 and temporarily recorded onto the RAM 12.

Also during the viewing of a program on the air, channel information about a channel that is being reproduced, acquired from the tuner 1, is managed by the CPU 11. The real time acquired from the system clock 18 is also managed by the CPU 11.

The modem 8 is connected to a public telephone line to realize communication between the video recording and reproducing apparatus and an external host. The modem 8 is used for receiving update information of the OS and application programs and for data transmission from the viewer to the broadcasting station, data server and the like. The above-described information (meta data) related to the contents of the program, acquired by the tuner 1, may be received via the modem 8.

The broadband network interface 7 is connected to a broadband network such as DSL (digital subscriber line), CATV or optical fiber to realize communication between the video recording and reproducing apparatus and an external host. The broadband network interface 7 is used for receiving update information of the OS and application programs and for data transmission from the viewer to the broadcasting station, data server and the like. The above-described information (meta data) related to the contents of the program, acquired by the tuner 1, may be received by the broadband network interface 7.

To transmit and receive information to and from a network such as the Internet by using the modem 8 and the broadband network interface 7, the video recording and reproducing apparatus carries general-purpose application programs such as a web browser. That is, these programs are stored in the storage 15 or in the ROM 13 and the non-volatile RAM 14, and suitably unfolded in the RAM 12 and then executed.

The video recording and reproducing apparatus according to this embodiment can support viewing and reproduction of a recorded video content on the basis of viewing support information provided from another party. The viewing support information described here includes channel information specifying a program with respect to each broadcast program, comments on a specific scene within the program, and on-air time at which the commented scene is put on the air. Therefore, on the user side where the viewing support information has been received, a scene on which preferred comments are made can be found by search easily or automatically, using the on-air time as a clue.

Such viewing support information may be exchanged, for example, between users. That is, a user who viewed a certain broadcast program on the air or a user who previously viewed recorded contents of the broadcast program may transmit viewing support information acquired or prepared through viewing the program to a user who has not viewed the program yet, via a network.

Alternatively, a specified server on the network may gather viewing support information of each program from unspecified users and make the viewing support information public. Such a server may make the information public about the program, for example, in a format like BBS (bulletin board system). The information sent from each user includes channel information specifying the program, comments on a specific scene in the program, and the on-air time at which the commented scene is put on the air. Therefore, the server side may set bulletin board, for example, for each program, array comments sent on each program in accordance with the on-air time and thus display a list of the comments. A user can search a world wide web information space such as the Internet and visiting such a bulletin board site to browse viewing support information contributed by other users.

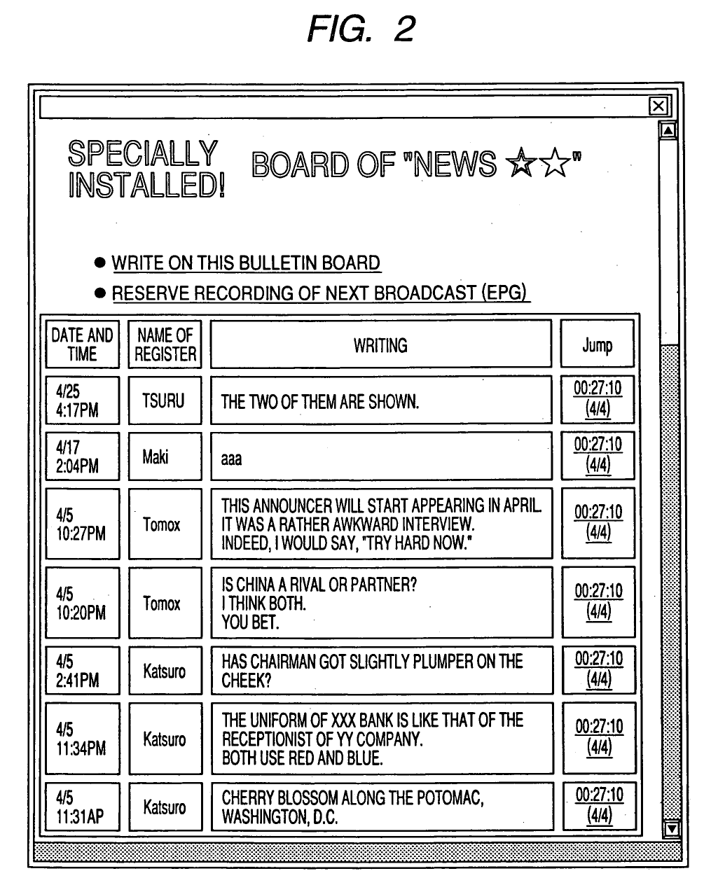

FIG. 2 shows an example of screen construction of a bulletin board on which comments on each scene of a certain program are gathered. In the example shown in FIG. 2, date and time of comment registration (registration), name of comment registerer, comment, that is, writing, and also offset time from start time of the program to the scene on which the comment is written or reproduction start point information, are shown.

For example, an anchor indicating a corresponding reproducing position of a broadcast content, or an anchor for starting processing to search for the corresponding reproducing position of the broadcast content is embedded in character strings of offset time on this bulletin board. In such a case, when the user browses the bulletin board and finds a comment that he/she likes, the user can click the offset time by using the mouse 18 so that the reproducing position of the recorded content automatically jumps to a corresponding scene.

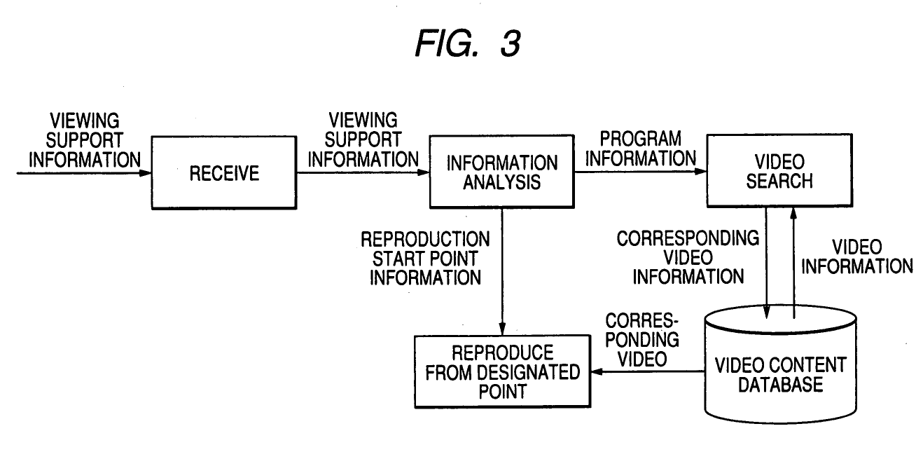

FIG. 3 schematically shows a mechanism for controlling the reproducing position of a recorded content on the basis of such viewing support information in the video recording and reproducing apparatus according this embodiment.

As shown in FIG. 3, in video recording and reproduction support according to this invention, viewing support information provided by another party on the network is received and analyzed to acquire program information and reproduction start point information. Then, using the acquired program information, a database is searched for a corresponding video content. Then, reproduction is started at a point designated by reproduction start time information.

The viewing support information is information for reproducing a video from a point supposed by the provider, and includes “broadcasting station”, “broadcast start date and time” and “offset” as minimum constituent elements. Here, “broadcasting station” represents the name of a broadcasting station that broadcast a program. “Broadcast start date and time” represents time information of the date and time when the program was broadcast. “Offset” represents information about which point within the video the reproduction should be started at, and it describes a time interval from the program start point to the point where reproduction is to be started.

The program information includes “broadcasting station” and “broadcast start date and time” of the viewing support information. Since information corresponding to the area where the video recording and reproducing apparatus is installed is sent as the program information, it can univocally determine the program.

The reproduction start point information includes “offset” of the viewing support information.

In the processing shown in FIG. 3, video reproduction supposed by the viewing support information provider is automatically started simply by carrying out a single operation to select one item from a list of viewing support information (see FIG. 2) displayed on, for example, a web browser where the user is browsing a bulletin board.

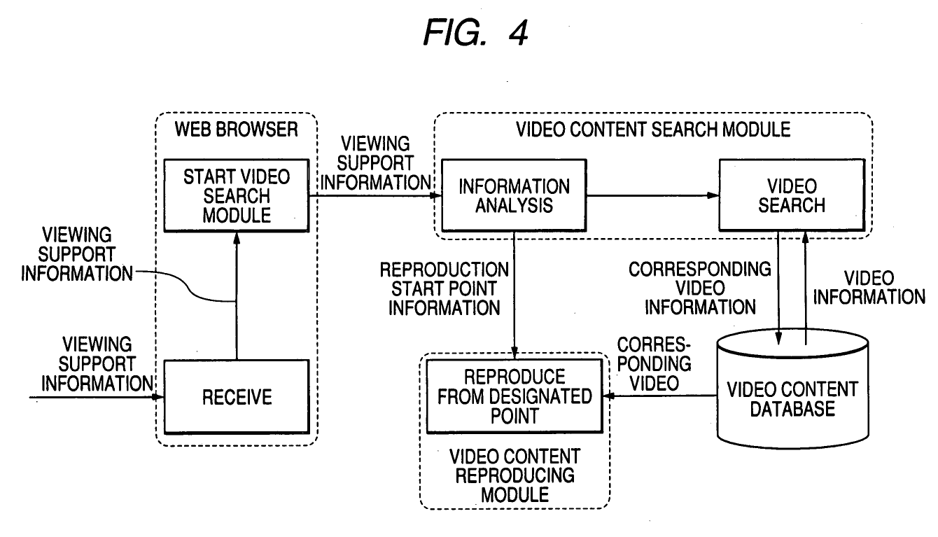

FIG. 4 schematically shows a mechanism for controlling the reproducing position of a recorded content on the basis of viewing support information in the case of receiving the viewing support information via a web browser.

In this case, when the viewing support information is received via the web browser, it is sent to a video content search module (hereinafter simply referred to as “search module”). At this point, the search module is automatically started by the web browser. The search module analyzes the viewing support information, then searches a database in this apparatus for a corresponding video content, and sends it to a video content reproducing module (hereinafter simply referred to as “reproducing module”). Reproduction start point information is also sent to the reproducing module at the same time.

The reproducing module reproduces the video content found by the search, from a reproducing position indicated by the reproduction start point information included in the viewing support information.

In practice, the search module and the reproducing module can be loaded as software modules that are unfolded from the storage 15, the non-volatile RAM 14 and the ROM 13 to the RAM 12 and executed by the CPU 11.

The search module searches the database of video contents for a program supposed by the viewing support information provider. In the search, the program information and the video content information are compared with each other and search is thus performed. The video content information includes at least “broadcasting station”, “recording start date and time” and “recording end date and time”. “Broadcasting station” represents the name of a broadcasting station that broadcast a recorded program. “Recording start date and time” and “recording end date and time” represent time information of time at which recording started and ended, respectively.

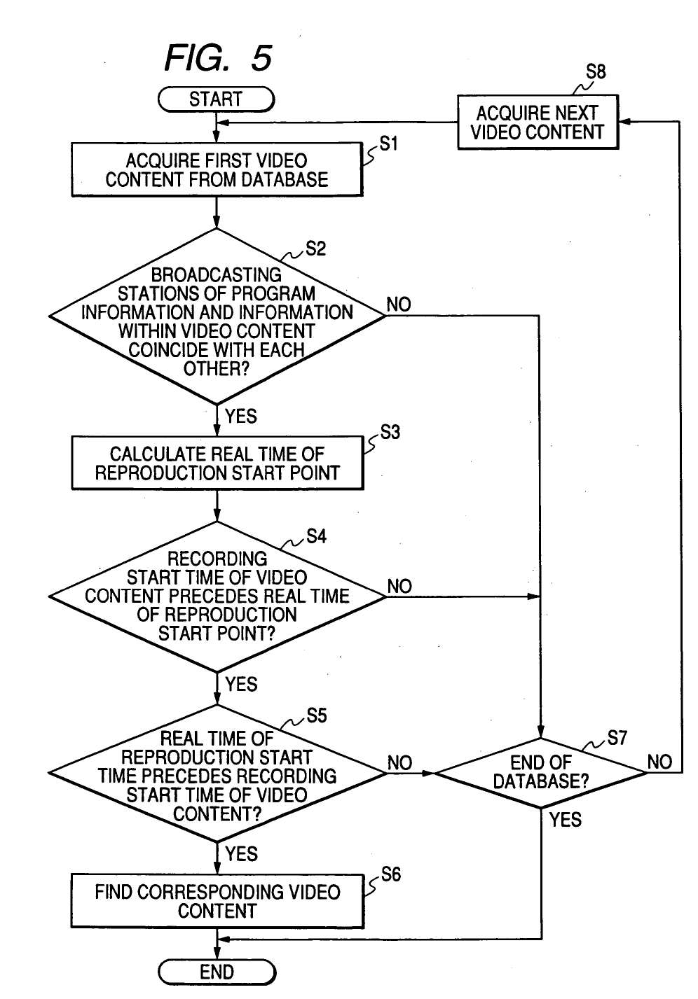

FIG. 5 shows processing procedures for searching for a video content on the search module, in the form of a flowchart.

First, the first video content is acquired from the database of video contents (step S1) and it is checked whether “broadcasting station” included the program information included in the viewing support information and “broadcasting station” included in the information within the video content coincide with each other (step S2).

If the “broadcasting stations” do not coincide with each other, it is checked whether the video content is at the end of the database (step S7). If it is not at the end of the database, the next video content is acquired from the database (step S8) and the processing returns to step S2 to repeatedly execute processing similar to the above-described processing. If it is at the end of the database, this whole processing routine ends.

On the other hand, if the “broadcasting stations” of the program information and the information within the video content coincide with each other, the real time of a reproduction start point is calculated then (step S3). The real time of the reproduction start point is calculated by adding the “offset” time of the reproduction start point information to “broadcast start date and time” of the program information.

Then, it is checked whether the real time of the reproduction start point is included between “recording start date and time” and “recording end date and time” of the video content information. This is determined by whether the recording start time of the video content precedes the real time of the reproduction start point (step S4) and whether the real time of the reproduction start point precedes the recording end time of the video content (step S5).

If the real time of the reproduction start point is included between the “recording start date and time” and “recording end date and time” of the video content information, it is assumed that the video content is a video content corresponding to the program information (step S6) and the video content search processing ends.

If it is judged that the real time of the reproduction start point is not included between the “recording start date and time” and “recording end date and time” of the video content information, it is checked whether the video content is at the end of the database (step S7). If it is not at the end of the database, the next video content is acquired from the database (step S8) and the processing returns to step S2 to repeatedly execute processing similar to the above-described processing. If it is at the end of the database, this whole processing routine ends.

Here, reproduction supposed by the viewing support information provider may not be carried out even when the “offset” time of the reproduction start point information is added as it is to the “recording start date and time” of the video content found by the search. This is because the “recording start date and time” of the video content information and the “broadcast start date and time” of the program information are different in some cases.

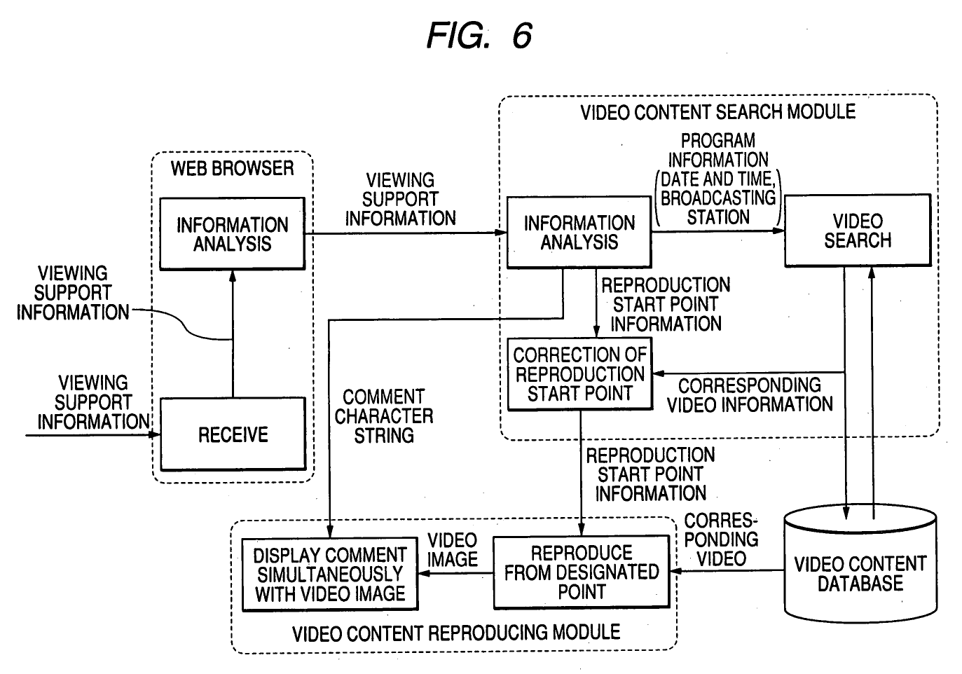

FIG. 6 schematically shows a mechanism for controlling the reproducing position of a video content based on viewing support information in consideration of such a situation.

In the example shown in FIG. 6, if the “recording start date and time” of the video content information differs from the “broadcast start date and time” of the program information, the reproduction start point information is corrected before carrying out video reproduction.

When the viewing support information is received by the web browser, it is sent to the search module. At this point, the search module is automatically started by the web browser. The search module analyzes the viewing support information, searches the database for a corresponding video content and sends it to the reproducing module. Character string information (for example, comments on the broadcast program or the like) taken out from the viewing support information is also sent to the reproducing module. The reproduction start point information is sent to the reproducing module after the reproduction start point is corrected within the search module. As a correction technique, the time difference between “recording start date and time” and “broadcast start date and time” is acquired, and if the “recording start date and time” precedes the “broadcast start date and time”, the time difference is added to “offset” to perform correction. In the opposite case, the time difference is subtracted from “offset”.

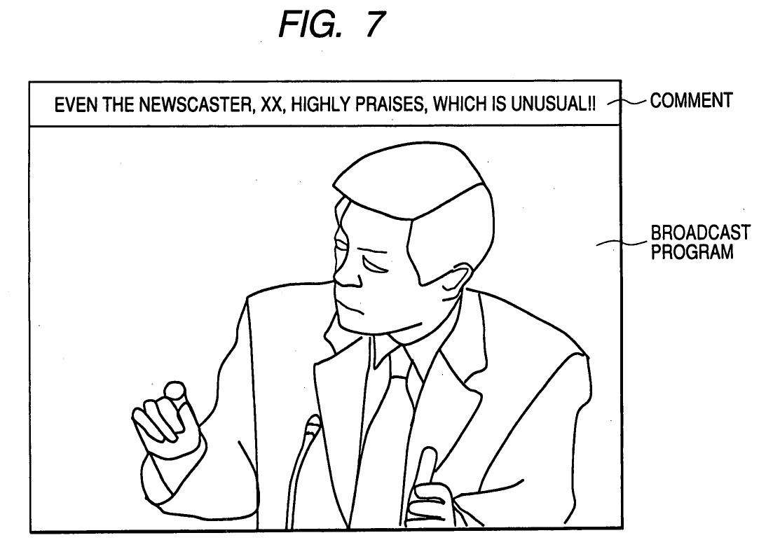

The reproducing module reproduces the video content found by the search, from a point designated by “offset” of the reproduction start point information. Start-up of the reproducing module is automatically carried out by the search module. At this point, character string information (comments on the broadcast program or the like) taken out from the viewing support information may be displayed simultaneously with a video reproduction image (see FIG. 7).

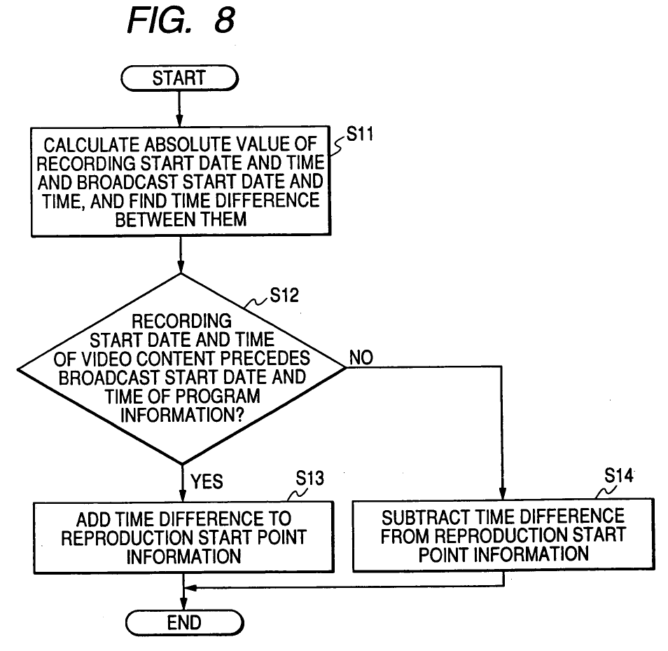

FIG. 8 shows processing procedures for correcting the reproduction start point in the case where the “recording start date and time” of the video content information differs from the “broadcast start date and time” of the program information in the search module, in the form of a flowchart.

First, the absolute value of difference between the recording start date and time and the broadcast start date and time is calculated (step S11), and it is then checked whether the recording start date and time of the video content precedes the broadcast start date and time of the program information (step S12).

Then, if the recording start date and time of the video content precedes the broadcast start date and time of the program information, the time difference is added to the reproduction start point information (step S13). If the program start date and time precedes the recording start date and time of the video content, the time difference is subtracted from the program start date and time (step S14).

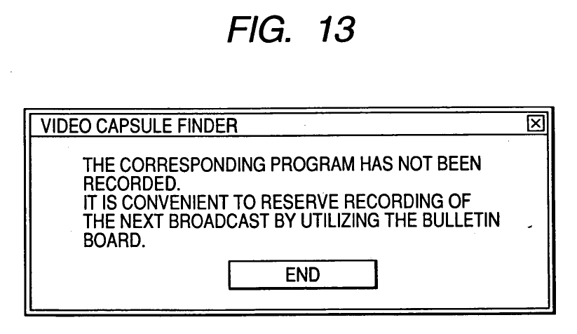

If none of the video contents in the database could be a search target in the search processing by the search module described above with reference to FIG. 5, search failure information is returned to the user as post-processing. For example, a method for reserving the next broadcast of the program, of the viewing support information, is displayed (see FIG. 13).

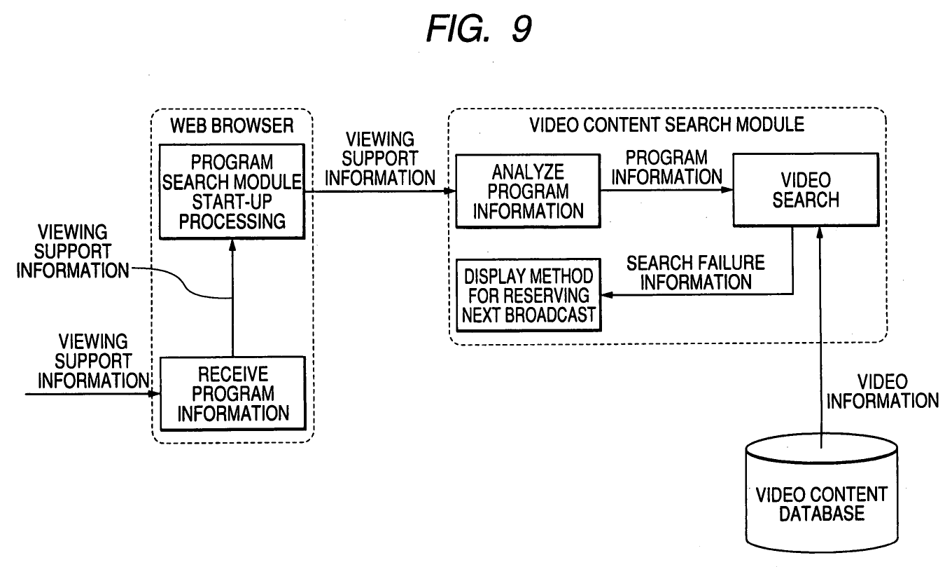

FIG. 9 schematically shows a mechanism for performing the post-processing in the case where search for a video content selected on the basis of the viewing support information failed.

In this case, when the viewing support information is received by the web browser, it is sent to the video content search module (hereinafter simply referred to as “search module”). At this point, the search module is automatically started by the web browser.

In the search module, the viewing support information is analyzed and the database is searched for a corresponding video content. If the search for the video content fails here, for example, a method for reserving the next broadcast is displayed on the screen of the display 5 as search failure information.

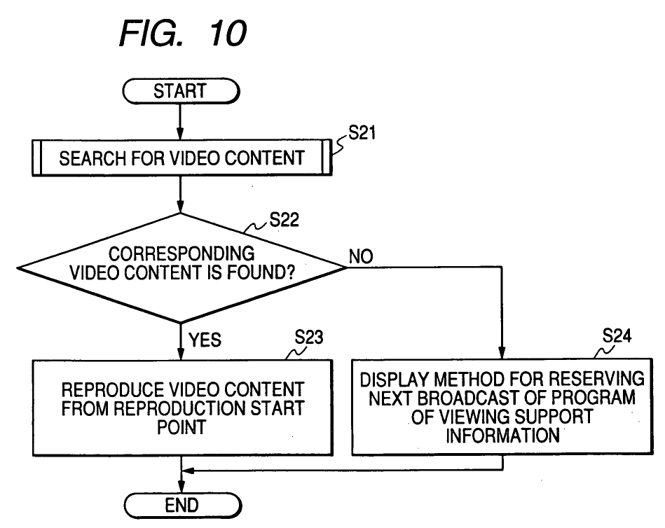

FIG. 10 shows procedures of the post-processing in the case where the search processing failed, in the form of a flowchart.

First, search for a video content is executed (step S21). Since the video content search processing is realized by the processing procedures shown in FIG. 5, it will not be described further in detail.

Next, it is checked whether a corresponding video content could be found (step S22).

If the video content could be found, the video content is sent to the reproducing module together with the reproduction start point information and is reproduced from a reproducing position indicated by the reproduction start point information included in the viewing support information (step S23).

On the other hand, if the video content could not be found, a method for reserving the next broadcast of the video content or the like is displayed on the screen of the display 5 (step S24). This reservation method is included, for example, in the viewing support information.

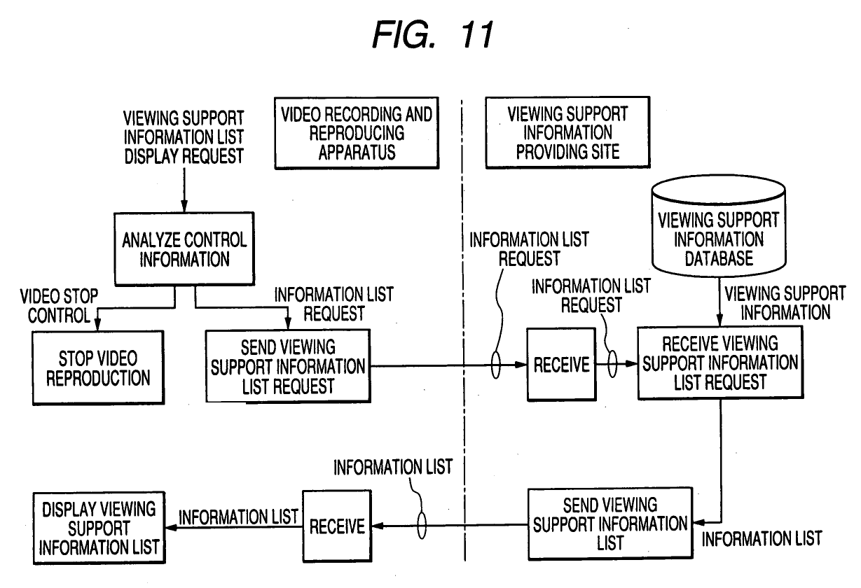

The viewing support information prepared and transmitted from plural viewing support information providers is arranged in order for each broadcast program and monistically managed, for example, on a viewing support information providing site constructed on a broadband network, and it is to be provided in accordance with a request from each user. FIG. 11 schematically shows a mechanism for the viewing support information site to provide the viewing support information in accordance with a request from a user, that is, the video recording and reproducing apparatus.

It is now assumed that a user requested the video recording and reproduction apparatus that performs viewing support for video contents, to display a list of the viewing support information, during reproduction of a normal recorded video or during video reproduction based on the viewing support information. In this case, control information is analyzed and decoded to operations of video stop control and information list display request. Then, the video content reproducing module stops the video reproduction once, and the web browser is started so that a viewing support information list request is sent to a site providing the viewing support information via a network.

On side of the viewing support information providing site, when the viewing support information is received, a viewing support information database is searched and the requested viewing support information is taken out to prepare a viewing support information list, which is then sent back to the requesting side.

In the video recording and reproducing apparatus, when the viewing support information list is acquired via the network, it is displayed on the screen of the display 5. The user can carry out this operation by a single operation, for example, pressing a button on the remote controller or the like.

As already described above, the viewing support information can include “comments” as a constituent element. “Comments” are character strings that the viewing support information provider can freely add at the time of preparing the information. Therefore, as a request for the viewing support information is made to the providing site during reproduction of a normal recorded video or during video reproduction based on the viewing support information, the reproducing module can display the “comments” on the screen simultaneously with a recorded image that is reproduced on the basis of the viewing support information.

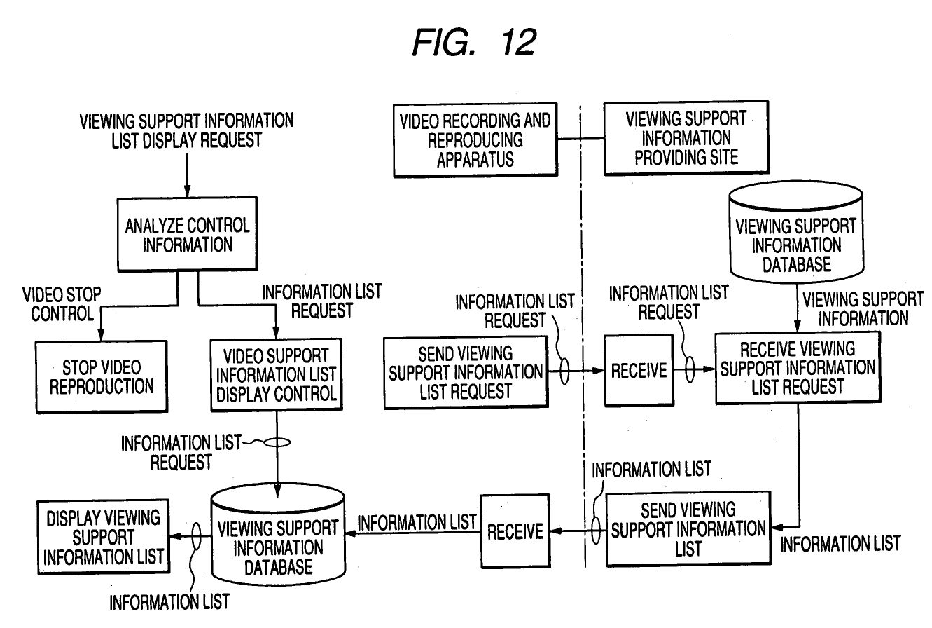

As the processing to acquire the viewing list information shown in FIG. 11 is performed automatically and periodically and the information is held in the database in the viewing support device, the viewing support information can be acquired off-line when the user requests it. FIG. 12 schematically shows a mechanism for the user, that is, the video recording and reproducing apparatus, to acquire the viewing support information list from the viewing support information site automatically and periodically.

In this case, on the side of the video recording and reproducing apparatus, the web browser is started automatically and periodically and a viewing support information list request is sent to the viewing support information providing site.

On the side of the viewing support information providing site, when the viewing support information is received, the viewing support information database is searched and the requested viewing support information is taken out to prepare a viewing support information list, which is then sent back to the requesting side.

Then, in the video recording and reproducing apparatus, when the list of the viewing support information is acquired via the network, it is stored into a viewing support information database within the apparatus. In this case, an updated part of the received viewing support information list may be outputted outward from the display 5 as newly arrived information.

It is now assumed that the user requested the video recording and reproduction apparatus that performs viewing support for video contents, to display the list of the viewing support information, during reproduction of a normal recorded video or during video reproduction based on the viewing support information. In this case, the control information is analyzed and decoded to operations of video stop control and information list display request. Then, the video content reproducing module stops the video reproduction once, and the viewing support information database in the apparatus is searched. Then, corresponding viewing support information is taken out and displayed on the screen of the display 5.

In this case, if the corresponding viewing support information could not found in the viewing support information database in the apparatus, the web browser may be started to send a viewing support information request to the viewing support information providing site.

As the viewing support information list is thus acquired on the user side automatically and periodically, the stress on the user due to network delay can be reduced and the existence of new information can be displayed.

Supplement

This invention is described above in detail with reference to the specific embodiment. However, it is obvious to those skilled in the art that modifications and substitutions can be made in the embodiment without departing from the scope of this invention. That is, this invention is disclosed above in the form of illustration and should not be interpreted in a limited way. To determine the scope of this invention, the section of claims should be referred to.

### INDUSTRIAL APPLICABILITY

As is described above in detail, according to this invention, it is possible to provide an excellent content recording and reproducing apparatus, content recording and reproducing method, and computer program that can support pleasant viewing by automating the processing in specifying and reproducing a scene in a recorded broadcast content.

Also, according to this invention, it is possible to provide an excellent content recording and reproducing apparatus, content recording and reproducing method, and computer program that can support pleasant viewing by automating the processing in reproducing a scene specified on the basis of information from an information provider.

According to this invention, when a user has received information from an information provider, the user can automatically find out a video content supposed by the information provider from many video contents existing in a database and can automatically carry out reproduction from a scene supposed by the information provider.

When performing such processing, the user need not carry out complicated operations and the processing can be automatically carried out simply by a single operation such as selecting a button. Also, reproduction from a scene supposed by the information provider can be carried out without considering the difference in video content recording start time between users.

Moreover, according to this invention, even when a viewing support function is not used, for example, during ordinary video content reproduction, the user need not carry out complicated operations and can display a screen for receiving the provision of viewing support information simply by a single operation, for example, pressing a button on a remote controller.

1. A content recording and reproducing apparatus for recording a content distributed in accordance with schedule time and supporting viewing, characterized by comprising:
content storage means for saving a distributed content together with a distribution channel and time information about time of saving;
receiving means for receiving viewing support information including at least distribution channel of the content, date and time of distribution of the content, and reproduction start point information of the content;
information analysis means for analyzing the viewing support information; and
content presentation means for taking out a corresponding content from the content storage means, and reproducing and outputting the content from a reproduction start point.

2. The content recording and reproducing apparatus as claimed in claim 1, characterized by further comprising
reproduction start point correction means for correcting the reproduction start point of the content on the basis of the reproduction start point information.

3. The content recording and reproducing apparatus as claimed in claim 2, characterized in that
the reproduction start point correction means compares saving start date and time of the content with distribution start date and time, and if the saving start date and time precede the distribution start date and time, the reproduction start point correction means adds time difference between them to the reproduction start point information, and if the distribution start date and time precede the saving start date and time, the reproduction start point correction means subtracts time difference between them from the reproduction start point information.

4. The content recording and reproducing apparatus as claimed in claim 1, characterized in that
the viewing support information includes a comment on the content, and
the content presentation means outputs the comment in parallel at a corresponding presentation position.

5. The content recording and reproducing apparatus as claimed in claim 1, characterized by further comprising
warning display means for displaying a warning to a user in response to the case where a content specified by viewing support information could not be taken out from the content storage means.

6. The content recording and reproducing apparatus as claimed in claim 5, characterized in that
the warning display means displays a method for reserving the next distribution of the content.

7. The content recording and reproducing apparatus as claimed in claim 1, characterized by further comprising:
viewing support information request means for acquiring one or more items of viewing support information; and
viewing support information list display means for displaying a list of the acquired viewing support information.

8. The content recording and reproducing apparatus as claimed in claim 7, characterized in that
the viewing support information request means acquires the viewing support information in accordance with a request from a user.

9. The content recording and reproducing apparatus as claimed in claim 7, characterized in that
the viewing support information request means acquires the viewing support information from an external device automatically and periodically,
the apparatus further comprises viewing support information storage means, and
the viewing support information list display means takes out the viewing support information from the viewing support information storage means in response to a request from a user and displays a list thereof.

10. The content recording and reproducing apparatus as claimed in claim 7, characterized in that
the list of the viewing support information is displayed by the viewing support information list display means after reproduction and output of the content by the content presentation means are stopped in response to a user's operation.

11. The content recording and reproducing apparatus as claimed in claim 7, characterized in that
in response to a user's selection from the list of the viewing support information by the viewing support information list display means, the information analysis means analyzes the selected viewing support information, and the content presentation means reproduces and outputs the corresponding content from a reproduction start point.

12. A content recording and reproducing method for recording a content distributed in accordance with schedule time and supporting viewing, characterized by comprising:
a content storage step of saving a distributed content together with a distribution channel and time information about time of saving;
a receiving step of receiving viewing support information including at least distribution channel of the content, date and time of distribution of the content, and reproduction start point information of the content;
an information analysis step of analyzing the viewing support information; and
a content presentation step of taking out a corresponding content from contents stored at the content storage step, and reproducing and outputting the content from a reproduction start point.

13. The content recording and reproducing method as claimed in claim 12, characterized by further comprising
a reproduction start point correction step of correcting the reproduction start point of the content on the basis of the reproduction start point information.

14. The content recording and reproducing method as claimed in claim 12, characterized in that
at the reproduction start point correction step, saving start date and time of the content is compared with distribution start date and time, and if the saving start date and time precede the distribution start date and time, time difference between them is added to the reproduction start point information, and if the distribution start date and time precede the saving start date and time, time difference between them is subtracted from the reproduction start point information.

15. The content recording and reproducing method as claimed in claim 12, characterized in that
the viewing support information includes a comment on the content, and
at the content presentation step, the comment is outputted in parallel at a corresponding presentation position.

16. The content recording and reproducing method as claimed in claim 12, characterized by further comprising
a warning display step of displaying a warning to a user in response to the case where a content specified by viewing support information could not be taken out from the contents stored at the content storage step.

17. The content recording and reproducing method as claimed in claim 16, characterized in that
at the warning display step, a method for reserving the next distribution of the content is displayed.

18. The content recording and reproducing method as claimed in claim 12, characterized by further comprising:
a viewing support information request step of acquiring one or more items of viewing support information; and
a viewing support information list display step of displaying a list of the acquired viewing support information.

19. The content recording and reproducing method as claimed in claim 18, characterized in that
at the viewing support information request step, the viewing support information is acquired in accordance with a request from a user.

20. The content recording and reproducing method as claimed in claim 18, characterized in that
at the viewing support information request step, the viewing support information is acquired from an external device automatically and periodically,
the method further comprises a viewing support information storage step, and
at the viewing support information list display step, the viewing support information stored at the viewing support information storage step is displayed in a list in response to a request from a user.

21. The content recording and reproducing method as claimed in claim 12, characterized in that
the list of the viewing support information is displayed by the viewing support information list display step after reproduction and output of the content by the content presentation step are stopped in response to a user's operation.

22. The content recording and reproducing method as claimed in claim 12, characterized in that
in response to a user's selection from the list of the viewing support information at the viewing support information list display step, the information analysis step analyzes the selected viewing support information, and the content presentation step reproduces and outputs the corresponding content from a reproduction start point.

23. A computer program described in a computer-readable format so as to execute processing to record a content distributed in accordance with schedule time and support viewing, on a computer system, characterized by comprising:
a content storage step of saving a distributed content together with a distribution channel and time information about time of saving;
a receiving step of receiving viewing support information including at least distribution channel of the content, date and time of distribution of the content, and reproduction start point information of the content;
an information analysis step of analyzing the viewing support information; and
a content presentation step of taking out a corresponding content from contents stored at the content storage step, and reproducing and outputting the content from a reproduction start point.
